(19) United States
(12) Patent Application Publication
(10) Pub. No.: US 2025/0250477 A1
(43) Pub. Date: Aug. 7, 2025

(54) POLYAMINE DENDRIMER ALUMINA NANOPARTICLES AND METHODS ASSOCIATED THEREWITH

(71) Applicants: SAUDI ARABIAN OIL COMPANY, Dhahran (SA); KING FAHD UNIVERSITY OF PETROLEUM & MINERALS, Dhahran (SA)

(72) Inventors: Bader G. AL-HARBI, Dhahran (SA); Norah A. ALJEABAN, Dhahran (SA); Tawfik A. SALEH, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/434,017

(22) Filed: Feb. 6, 2024

(51) Int. Cl. C09K 8/54

(52) U.S. Cl. CPC C09K 8/54; C09K 2208/10; C09K 2208/32

(57) ABSTRACT

Treatment fluids may be used within a subterranean formation in various treatment operations during hydrocarbon extraction processes. As an example, a method of use of a treatment fluid may include: providing a treatment fluid including a plurality of alumina nanoparticles that are surface modified with a polyamine dendrimer; introducing the treatment fluid into a subterranean formation; and interacting the alumina nanoparticles with a surface subject to corrosion.

### FIELD OF THE DISCLOSURE

The present disclosure relates generally to corrosion inhibition and, more particularly, to mitigation of corrosion associated with hydrocarbon production.

### BACKGROUND OF THE DISCLOSURE

Stimulation operations may be performed on a subterranean formation to achieve, increase, or restore production of a hydrocarbon resource (e.g., oil and/or gas) therefrom. Stimulation operations may include, for example, matrix acidizing, fracturing, and acid fracturing. The type of stimulation operation employed in a particular circumstance may depend on factors including the geology of the formation and the type of hydrocarbons being produced.

Matrix acidizing involves introduction of a treatment fluid comprising an aqueous acid into a subterranean formation through a wellbore. The aqueous acid may interact with the matrix of the subterranean formation and promote formation of wormholes, through which a hydrocarbon resource may better flow for subsequent production.

Although effective for promoting production of a hydrocarbon resource, the aqueous acid may produce concurrent undesirable effects. Stimulation operations may employ equipment at the surface or within the subterranean formation (e.g., in the wellbore), which may be used to convey the treatment fluid into the subterranean formation or may come into incidental contact with the treatment fluid during a stimulation operation. Such equipment used may be manufactured from metals that are subject to corrosion, such as steel. As used herein, the term “corrosion” and grammatical variations thereof refers to any reaction between a metal and a corrosive environment to cause a deterioration of the metal or its morphology, Examples of corrosion damage may include, but are not limited to, rusting, metal dissolution or erosion, pitting, peeling, blistering, patina formation, combinations thereof, and the like.

Corrosion inhibitors may be used to at least partially suppress corrosion. A wide range of corrosion inhibitors are known. Examples include aromatic aldehydes, quaternary salts, acetylenic alcohols, N-heterocycles, carbonyl compounds, and amines. Unfortunately, many of these compounds are expensive, work most effectively at high concentrations, and/or present environmental issues. Another strategy for preventing corrosion is to form a polymer coating on a surface subject to corrosion. Although this strategy may likewise be effective, it too may be problematic from a cost standpoint. Accordingly, additional strategies to aid in mitigating the effects of corrosion would be highly desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Nonlimiting example methods of the present disclosure may include: providing a treatment fluid comprising a plurality of alumina nanoparticles that are surface modified with a polyamine dendrimer; introducing the treatment fluid into a subterranean formation; and interacting the alumina nanoparticles with a surface subject to corrosion.

Nonlimiting example compositions of the present disclosure may include: a plurality of alumina nanoparticles that are surface modified with a polyamine dendrimer.

Nonlimiting example methods of the present disclosure may include: providing a plurality of alumina nanoparticles; reacting a diamine with the alumina nanoparticles to bond a first amine group of the diamine to a surface of the alumina nanoparticles; wherein a second amine group of the diamine is linked to the first amine group; and reacting the second amine group of the diamine to form a plurality of amine-containing branches extending from the second amine group. Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Not applicable.

### DETAILED DESCRIPTION

Embodiments in accordance with the present disclosure generally relate to corrosion inhibition and, more particularly, to mitigation of corrosion associated with hydrocarbon production.

The present disclosure provides modified alumina nanoparticles that may be effective for mitigating the effects of corrosion while also addressing difficulties associated with conventional types of corrosion inhibitors. The modified alumina nanoparticles described herein may provide benefits such as, for example, a large surface area to facilitate coverage, relatively low cost, good mechanical strength, good impermeability, and excellent chemical resistance toward corrosive substances and environments. The modified alumina nanoparticles described herein, in contrast to other types of nanoparticles, may be readily dispersible in aqueous fluids to aid in facilitating their introduction into a subterranean formation for mitigating corrosion therein.

In particular, the present disclosure provides alumina nanoparticles that are surface modified with a polyamine dendrimer. Such modified nanoparticles may be referred to hereinafter as polyamine dendrimer alumina nanoparticles. Advantageously, such modified nanoparticles may be readily synthesized and further manipulated, as described further herein.

Compositions of the present disclosure may comprise alumina nanoparticles that are surface modified with a polyamine dendrimer (polyamine dendrimer alumina nanoparticles). As used herein, the term “polyamine dendrimer” refers to a substituted hydrocarbyl structure containing two or more branches, wherein the two or more branches establish the dendrimeric nature of the modified alumina nanoparticles. As described further below, the two or more branches are further linked to the surface of the alumina nanoparticles by a diamine moiety, wherein a first amine group of the diamine is bound to the surface of the alumina nanoparticles and a second amine group of the diamine provides a branching point for the two or more branches. The diamine moiety is described further below and may or may not be branched. Methods for synthesizing the polyamine dendrimer alumina nanoparticles and further description of the nature of the polyamine dendrimer extending from the surface of the alumina nanoparticles are provided hereinbelow. The polyamine dendrimer alumina nanoparticles of the present disclosure may interact with a surface subject to corrosion to provide corrosion inhibition thereof, as also discussed further below.

Polyamine dendrimer alumina nanoparticles of the present disclosure may have a structure represented by one or more of Formulas 1 and 2 below.

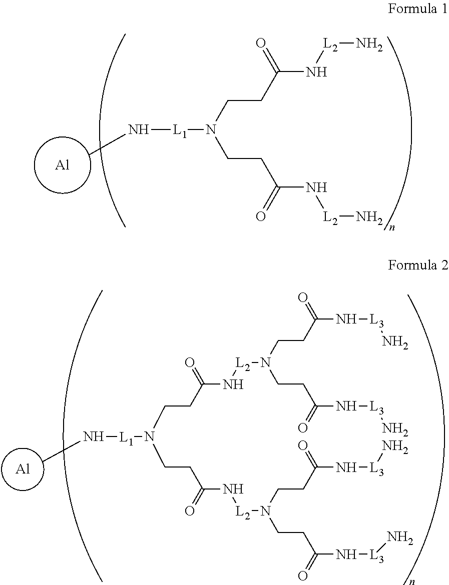

In Formulas 1 and 2, Al is an alumina nanoparticle, n is a positive integer, and L₁, L₂, and L₃ (if present) are independently an optionally substituted hydrocarbyl linking group. In more specific examples, L₁, L₂, and L₃ (if present) are each an alkylene group, such as a C₂-C₁₂ alkylene group, or a C₂-C₈ alkylene group, or a C₂-C₆ alkylene group, or a C₂-C₄ alkylene group; an arylene group, such as 1,2-phenylene, 1,3-phenylene, or 1,4-phenylene; or a cycloalkylene group, such as 1,2-cyclohexylene, including the various stereoisomers thereof. Optionally, the hydrocarbyl linking group may be branched and/or bear optional heteroatom substitution, either within the linking group as a chain or ring atom or as a side chain of the linking group.

L₁, L₂, and L₃ (if present) may contain the same number of carbon atoms, or one or more of L₁, L₂, and L₃ (if present) may contain differing numbers of carbon atoms. In some examples, L₁, L₂, and L₃ (if present) may each be a C₂-C₁₂ alkylene group, or a C₂-C₈ alkylene group, or a C₂-C₆ alkylene group, or a C₂-C₄ alkylene group, each containing the same number of carbon atoms. In still more specific examples, L₁, L₂, and L₃ (if present) may each be a C₂ alkylene group. Formulas 1A and 2A below are representations of the structures of the polyamine dendrimer alumina nanoparticles when L₁, L₂, and L₃ (if present) are each a C₂ alkylene group.

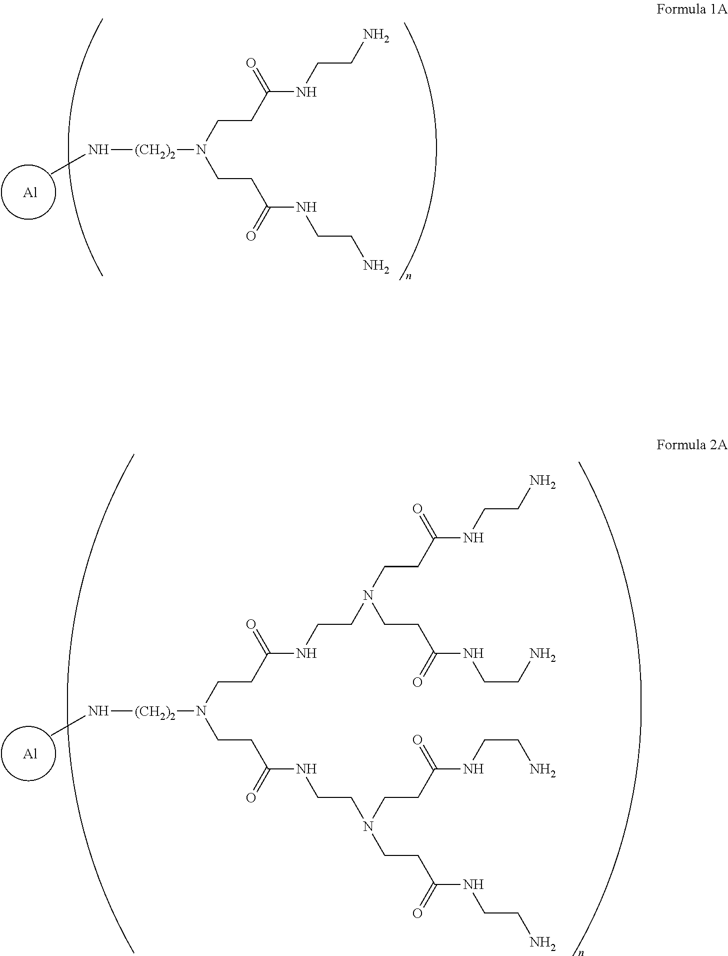

As shown in Formulas 1, 1A, 2, and 2A above, the polyamine dendrimer may comprise a plurality of amine-containing branches extending from an amine group remote from the surface of the alumina nanoparticles. The amine group that is remote from the surface of the alumina nanoparticles is linked by L₁ (e.g., CH₂CH₂) to the amine group that is bound to the surface of the alumina nanoparticles. In Formulas 1 and 1A, there are two amine-containing branches extending from the amine group remote from the surface of the alumina nanoparticles, each containing another amine group at the terminus of the amine-containing branch. As shown, the amine group at the terminus of the amine-containing branch is a primary amine, but the terminal amine may be a secondary or tertiary amine in some instances. In Formulas 2 and 2A, the two amine-containing branches of Formulas 1 and 1A are further branched to yield four amine-containing branches, each having a primary amine at a terminus thereof. Thus, although Formulas 1/1A and 2/2A have depicted two and four amine-containing branches, respectively, it is to be appreciated that more highly branched polyamine dendrimers may be produced by iteratively extending the polyamine branches according to the synthesis procedures described further hereinbelow.

Moreover, the amine-containing branches depicted in Formulas 1/1A and 2/2A each contain an amide linker between the amine group remote from the surface of the alumina nanoparticles and the amine group at the terminus of the amine-containing branch. It is to be appreciated that other linking groups between these two amines are also possible through alternative syntheses and reside within the scope of the present disclosure.

Methods for synthesizing the polyamine dendrimer alumina nanoparticles of the present disclosure may comprise: providing a plurality of alumina nanoparticles; reacting a diamine with the alumina nanoparticles to bond a first amine group of the diamine to a surface of the alumina nanoparticles, thereby leaving a second group remote from the surface of the alumina nanoparticles and linked to the first amine group; and reacting the second amine group of the diamine to form a plurality of amine-containing branches extending from the second amine group. Reaction of the second amine group to form the amine-containing branches may take place after the first amine group has already been bonded to the surface of the alumina nanoparticles.

More specifically, reacting the second amine group of the diamine to form the plurality of amine-containing branches may comprise exposing the second amine group to an electrophile under reaction conditions suitable to react the second amine group with the electrophile. To form multiple amine-containing branches, the second amine group may react with two equivalents of the electrophile under the reaction conditions. Suitable reaction conditions for reacting amine groups with various types of electrophiles will be familiar to persons having ordinary skill in the art. Formula 3 is a representation of the product structure resulting from a reaction of alumina nanoparticles with a diamine, and Formula 4 is a representation of the product structure resulting from subsequent reaction of the remote amine group in Formula 3 with an electrophile.

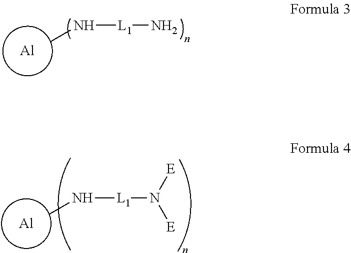

In Formulas 3 and 4, L₁ is an optionally substituted hydrocarbyl linker group, as defined above, such as a C₂-C₁₂ alkylene group, preferably a C₂ alkylene group, and E is the reaction product of an electrophile. Variable n is likewise defined as above.

Suitable diamines providing the optionally substituted hydrocarbyl spacer group L₁ in Formulas 3 and 4 may include any C₂-C₁₂ alkylenediamine, such as ethylenediamine, 1,3-propylenediamine, 1,4-butylenediamine, 1,6-hexanediamine, and the like. Polyamines such as diethylenetriamine, triethylenetetramine, tetraethylenepentamine, and the like may also be used. Amine polymers such as polyethylenimine or polyaziridine, which may be linear or branched, may also be used in some cases. Preferably, the diamine used to produce the functionalized alumina nanoparticles represented by Formula 3 comprises ethylenediamine. Alternately, an arylenediamine may be used, such as an optionally substituted 1,2-phenylenediamine, 1,3-phenylenediamine, or 1,4-phenylenediamine.

The alumina nanoparticles undergoing surface modification with a polyamine dendrimer according to the disclosure herein may be present in a range of particle sizes. In non-limiting examples, the alumina nanoparticles may have an average particle size (D50) ranging from about 40 nm to about 200 nm.

Likewise, the manner in which the alumina nanoparticles are synthesized is not believed to be particularly limited. In one example, the alumina nanoparticles may be synthesized through hydrolysis of an aluminum alkoxide (e.g., aluminum isopropoxide), followed by peptization and a dehydration reaction. Hydrolysis of the aluminum alkoxide may be conducted in an aqueous solution (e.g., water) by adding the aluminum alkoxide at a molar ratio of about 1 mol alkoxide per about 200 moles water. Hydrolysis of the aluminum alkoxide may occur at an elevated temperature over an extended period of time. Suitable elevated temperatures may include a temperature ranging from about 70° C. to about 150° C., or about 80° C. to about 120° C., or preferably about 100° C. to about 120° C. and over a time of about 1 hour to about 10 hours, or about 3 hours to about 5 hours.

Peptization of the aluminum hydroxide from hydrolysis may occur to form colloidal alumina. Peptization may take place in an acid at an elevated temperature. Suitable acids may include mineral acids such as, for example, hydrochloric acid. The acid may be present at a molar ratio of about 0.05 moles acid per about 1 moles of the original aluminum alkoxide. Suitable elevated temperatures may include a temperature ranging from about 70° C. to about 150° C., or about 80° C. to about 120° C., or about 100° C. to about 120° C. and over a time of about 1 hour to about 24 hours, or about 1 hours to about 5 hours, or 24 hours or greater.

Colloidal alumina particles undergo a subsequent dehydration reaction using a reagent suitable to perform dehydration to form the alumina nanoparticles. Suitable examples of reagents for performing dehydration may include, but are not limited to, sodium bis-2-ethylhexyl sulfosuccinate, the like, or any combination thereof. The dehydration reagent may be present at a molar ratio of about 0.02 moles reagent per about 1 moles of the original aluminum alkoxide. The dehydration reaction may occur at an elevated temperature. Suitable elevated temperatures may include a temperature ranging from about 70° C. to about 150° C., or about 80° C. to about 120° C., or about 100° C. to about 120° C. over a time of about 1 hour to about 24 hours, or about 1 hour to about 5 hours, or 24 hours or greater.

The reaction to bond the diamine or other polyamine compound to the surface of the alumina nanoparticles may take place at an elevated temperature, preferably with sonication, to promote bonding between a first amine group of the polyamine and the surface of the alumina nanoparticles. Suitable elevated temperatures may range from about 50° C. to about 100° C., or about 60° C. to about 90° C., or about 60° C. to about 80° C. over a time from about 1 hour to about 72 hours, or about 1 hour to about 36 hours, or about 1 hour to about 24 hours, or about 1 hour to about 12 hours, or about 1 hour to about 6 hours.

In non-limiting examples, the electrophile reacted with the second amine group of Formula 3 may be a Michael acceptor. As will be understood by one of ordinary skill in the art, Michael acceptors are α,β-unsaturated carbonyl compounds. Preferably, the Michael acceptor is an α,β-unsaturated ester, such as acrylate ester. The term “acrylate ester” refers equivalently to esters formed from either of acrylic acid or methacrylic acid. Formula 5 below represents the structure of the reaction product of Formula 3 with an acrylate ester, such as ethyl acrylate. In Formula 5, R is s C₁-C₁₀ alkyl group, such as methyl, ethyl, propyl, or butyl, for example. Variable n and L₁ are likewise defined as above.

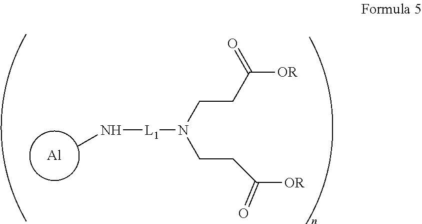

Methods of reacting an acrylate ester with alumina nanoparticles having a structure represented by Formula 3 may include dispersing the modified alumina nanoparticles in a suitable solvent (e.g., methanol) containing the acrylate ester. The reaction between the remote amine and the acrylate ester may occur through a Michael addition taking place at an elevated temperature. Suitable elevated temperatures may range from about 50° C. to about 100° C., or about 60° C. to about 90° C., or about 60° C. to about 80° C. over a time of about 1 hour to about 72 hours, or about 1 hour to about 36 hours, or about 1 hour to about 24 hours, or about 1 hour to about 12 hours, or about 1 hour to about 6 hours.

Electrophiles other than Michael acceptors may also be suitable in some cases. For example, an alkyl group bearing a leaving group and the functional equivalent of an amine (e.g., a protected amine or a group that may be converted to an amine) may be reacted with the primary amine of Formula 3 to afford electrophile functionalization with an alternative polyamine dendrimer structure. One having ordinary skill in the art will appreciate the types of structures that may be formed, and in the interest of brevity, such structures are not described further herein.

Finally, the ester moieties of Formula 5 may be converted into amide functionalities through aminolysis with an amine. More specifically, to convert the electrophile reaction product of Formula 5 into two amine-containing branches, a diamine may be reacted with the ester moieties to displace an alcohol (e.g., ROH) and install amide bonds in their place. Functionalized alumina nanoparticles (polyamine dendrimer alumina nanoparticles) having a structure represented by Formula 1 may be obtained from the aminolysis reaction. Suitable diamines for conducting the aminolysis reaction to afford the structure represented by Formula 1 may include the diamines used to produce the functionalized alumina nanoparticles represented by Formula 3, as discussed in detail above. Moreover, the diamine used to conduct the aminolysis reaction may be the same as or different than the diamine used to form the modified alumina nanoparticles having a structure represented by Formula 3.

The polyamine dendrimer alumina nanoparticles having a structure represented by Formula 1 contain two amine-containing branches extending from a tertiary amine (the amine remote from the surface of the alumina nanoparticles). The amines in the amine-containing branches may be further functionalized to produce more extensively branched dendrimers. Specifically, the two primary amines in Formula 1 may be sequentially reacted with an electrophile (e.g., a Michael acceptor, such as ethyl acrylate) and a diamine (e.g., ethylenediamine) to afford four amine-containing branches from the original two amine-containing branches, as shown in Formula 2. The four amine-containing branches in Formula 2 may be converted into additional amine-containing branches in a similar manner. In the interest of brevity, such additional branch formation is not described further or depicted herein.

The polyamine dendrimer alumina nanoparticles described herein may be formed to a treatment fluid for use in a subterranean formation. The term “treatment fluid,” and grammatical variants thereof, refers to any fluid that may be used in a subterranean treatment operation (also referred to simply as “treatment” or “operation” herein) in conjunction with performing a desired function. The term “treatment fluid” does not imply any particular action by the fluid or any component thereof. The subterranean formation may contain a corrosive environment, or the treatment fluid itself may provide a corrosive environment that may cause corrosion of a surface susceptible to corrosion. For example, the treatment fluid may comprise an aqueous acid that may promote corrosion of a surface susceptible to corrosion. The polyamine dendrimer alumina nanoparticles decrease, limit, or prevent corrosion from occurring on a surface susceptible to corrosion in the presence of the corrosive environment.

Accordingly, methods of the present disclosure may comprise: providing a treatment fluid comprising a plurality of alumina nanoparticles that are surface modified with a polyamine dendrimer; introducing the treatment fluid into a subterranean formation; and interacting the alumina nanoparticles with a surface subject to corrosion. The surface subject to corrosion may be present in the subterranean formation (e.g., a tool or casing), within the wellhead, or any combination thereof. Any of the polyamine dendrimer alumina nanoparticles described herein may be utilized in regard to the foregoing.

The treatment fluid may comprise an aqueous fluid in which the polyamine dendrimer alumina nanoparticles are dispersed. Suitable aqueous fluids may include, but are not limited to, fresh water (e.g., stream water, lake water, or municipal treated water), non-potable water such as gray water or industrial process water, sea water, brine, aqueous salt solutions, partially desalinated water, produced water (including brine and other salt water solutions), the like, or any combination thereof.

An aqueous acid may be present in the treatment fluid, wherein the aqueous acid may be an acid suitable for performing matrix acidizing of a subterranean formation. Suitable aqueous acids may include, but are not limited to, mineral acids (e.g., hydrochloric acid or hydrobromic acid), hydrofluoric acid, or organic acids such as formic acid, acetic acid, propionic acid, methanesulfonic acid, chloroacetic acid, dichloroacetic acid, trichloroacetic acid, trifluoroacetic acid, the like, or any combination thereof. The treatment fluids may have an acid concentration of about 5 wt % to about 50 wt %, or about 10 wt % to about 40 wt %, or about 10 wt % to about 30 wt %, based on total mass of the treatment fluid.

The polyamine dendrimer alumina nanoparticles may be present in the treatment fluid at any suitable concentration including about 1 part per million (ppm) to about 1000 ppm, or about 1 ppm to about 500 ppm, or about 100 ppm to about 500 ppm, or about 200 ppm to about 400 ppm, or about 200 ppm to about 500 ppm, or about 200 ppm to about 1000 ppm, or about 300 ppm to about 1000 ppm, or about 1 ppm to about 300 ppm, or about 300 ppm), based on total volume of the treatment fluid.

The treatment fluids described herein may further include one or more additional components suitable for achieving one or more desired functions (e.g., in addition to the stimulation operation in question or providing corrosion inhibition in accordance with the disclosure herein). Examples of suitable additional components may include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a lost circulation material, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, an iron control agent, the like, or any combination thereof. Suitable examples of the foregoing will be familiar to one having ordinary skill in the art.

The treatment fluids described herein may be used in conjunction with acid fracturing, matrix acidizing, or any combination thereof. In addition, the treatment fluids may also be used in conjunction with scale dissolution operations as well. Scale dissolution may take place using mineral acids, organic acids, or any combination thereof, and may likewise be subject to the occurrence of corrosion.

The treatment fluids disclosed herein may be formulated at a remote location from a job site and shipped thereto or, in other embodiments, the treatment fluids may formulated at a job site. The polyamine dendrimer alumina nanoparticles may be obtained already dispersed in a fluid to be combined into the treatment fluids or may be obtained as a dry powder and combined with other components. In still other embodiments, the treatment fluid may be mixed and pumped into a subterranean formation on-the-fly. A person having ordinary skill in the art of designing and using such fluids will be able to consider these factors with the benefit of this disclosure and determine whether remote mixing, on-site mixing, or any other suitable mixing protocol is most appropriate for a given operation.

Systems used for handling treatment fluids of the present disclosure in the course of conducting a stimulation operation or similar treatment operation in a subterranean formation may include one or more mixing and/or storage tanks used for mixing and/or storing, respectively, treatment fluids prior to use in a stimulation operation. Additional tanks may be used for storing spent or partially spent treatment fluid removed from a subterranean formation as part of a stimulation operation. Following a stimulation operation, the treatment fluids or a spent or partially spent variant thereof may be produced from the subterranean formation during aqueous fluid flowback.

Systems for introduction of treatment fluids to a wellbore in conjunction with a stimulation operation may comprise a pump fluidly coupled to a tubing, the tubing located at least partially within the wellbore and the tubing containing a treatment fluid for a desired stimulation operation. The “pump” described herein may comprise a single pump or may comprise one or more pumps which may include “high pressure” and “low pressure” pump(s) in any combination. A “high pressure” pump, i.e., a pump operating at a pressure greater than about 1000 psi, may be used in stimulation operations according to the present disclosure such as acid fracturing where fracturing of the subterranean formation at a pressure higher than the fracture gradient pressure is required. A “low pressure” pump, i.e., a pump operating at a pressure of about 1000 psi or less, may be used in stimulation operations such as matrix acidizing where lower pressures are needed and where fracturing of the subterranean formation is not required. Given the benefit of the present disclosure, one having ordinary skill in the art will be able to select an appropriate pump or combination of pumps for a given stimulation operation.

The treatment fluids of the present disclosure may be injected using the pump(s) into the subterranean formation using the wellbore tubing located within the wellbore. The wellbore tubing may comprise metal piping, preferably steel piping, and more preferably carbon steel piping. The treatment fluid used in a particular stimulation operation may flow downhole through the wellbore tubing and flow out of the tubing into the subterranean formation in order to carry out the stimulation operation. Subsequently, in some stimulation operations including matrix acidizing and acid fracturing, the treatment fluid of a particular stimulation operation may be flowed back to the wellhead along with residual components which may include, for example, the acid-soluble material dissolved from the formation matrix during an acidizing operation. The treatment fluid and residual components may flow through the wellbore tubing or the wellbore annulus and back to the wellhead. Corrosion may occur during any of these instances and may be at least partially suppressed with the polyamine dendrimer alumina nanoparticles and associated compositions disclosed herein.

It should be noted that additional nonlimiting components may be present in systems suitable to introduce the treatment fluids to a subterranean formation and to recover fluid from the subterranean formation following stimulation. Such additional components will be familiar to one having ordinary skill in the art and include, but are not limited to, supply hoppers, valves, condensers, adapters, joints, gauges, sensors, compressors, pressure controllers, pressure sensors, flow rate controllers, flow rate sensors, temperature sensors, the like, or any combination thereof.

It is also to be recognized that the disclosed treatment fluids comprising the polyamine dendrimer alumina nanoparticles of the present disclosure may affect various equipment that may come into contact with the treatment fluids during operation, including in a manner such that the polyamine dendrimer alumina nanoparticles provide corrosion mitigation to surfaces of the equipment. Without being bound by theory, the modified alumina nanoparticles and any associated components of the treatment fluid may provide corrosion mitigation to surfaces of equipment through any suitable method including, attachment, coating, chemical bonding (e.g., covalent bonding, ionic bonding, the like or any combination thereof), chemical reaction with surfaces, the like, or any combination thereof. Continuing to not be bound by theory, the modified alumina nanoparticles may adsorb to surfaces of equipment forming a layer that provides corrosion mitigation.

Furthermore, it should be noted that although the compositions of the present disclosure are described as providing corrosion inhibition in association with stimulation operations and during scale removal, it is envisioned that compositions described herein may be used to prevent corrosion in any suitable application, including, for example, a pipeline, a storage tank, a processing unit, the like, or any combination thereof.

Embodiments disclosed herein include:
A. A method comprising: providing a treatment fluid comprising a plurality of alumina nanoparticles that are surface modified with a polyamine dendrimer; introducing the treatment fluid into a subterranean formation; and interacting the alumina nanoparticles with a surface subject to corrosion.
B. A composition comprising: a plurality of alumina nanoparticles that are surface modified with a polyamine dendrimer.
C. A method comprising: providing a plurality of alumina nanoparticles; reacting a diamine with the alumina nanoparticles to bond a first amine group of the diamine to a surface of the alumina nanoparticles; wherein a second amine group of the diamine is linked to the first amine group; and reacting the second amine group of the diamine to form a plurality of amine-containing branches extending from the second amine group.

Each of embodiments A through C may have one or more of the following additional elements in any combination:
Element 1: wherein the polyamine dendrimer is bound to a surface of the alumina nanoparticles by a first amine group and a plurality of amine-containing branches extend from a second amine group that is linked to the first amine group.
Element 2: wherein the amine-containing branches contain a third amine group at a terminus thereof.
Element 3: wherein the third amine group is a primary amine.
Element 4: wherein the amine-containing branches contain an amide linker between the second amine group and the third amine group.
Element 5: further comprising: interacting the surface subject to corrosion with a corrosive environment.
Element 6: wherein the corrosive environment comprises an aqueous acid.
Element 7: wherein the treatment fluid provides the corrosive environment.
Element 8: wherein the treatment fluid comprises an aqueous acid, and the alumina nanoparticles are dispersed in the aqueous acid.
Element 9: wherein the surface subject to corrosion is located in the subterranean formation.
Element 10: further comprising: an aqueous acid in which the alumina nanoparticles are dispersed.
Element 11: wherein reacting the second amine group comprises exposing the second amine group to an electrophile under reaction conditions suitable to react the second amine group with the electrophile; wherein the second amine group reacts with two equivalents of the electrophile under the reaction conditions.
Element 12: wherein the electrophile is a Michael acceptor.
Element 13: wherein the Michael acceptor is an acrylate ester.
Element 14: wherein, after reacting the acrylate ester with the second amine group; a second diamine is reacted with the acrylate ester to form the amine-containing branches.
Element 15: wherein providing the alumina nanoparticles comprises peptizing aluminum hydroxide to form a plurality of colloidal alumina particles and dehydrating.

By way of non-limiting example, exemplary combinations of Elements applicable to A through C include: 1 and 2; 1 and 3; 1-3; 1-2 and 4; 1-4.

Further exemplary combinations of Elements applicable to A and C include: 1 and 5; 1-5; 1 and 5-6; 5-6; 5-7; 5 and 8; 5-8; 5 and 9; 5-9; 1-3 and 5-9.

Further exemplary combinations of Elements applicable to B include: 1 and 10; 1-2 and 10; 1-3 and 10; 1-4 and 10.

Further exemplary combinations of Elements applicable to C include: 11 and 12; 11-13; 11-14; 11 and 14-15; 11 and 15.

Further exemplary embodiments may include:
Clause 1. A method comprising: providing a treatment fluid comprising a plurality of alumina nanoparticles that are surface modified with a polyamine dendrimer; introducing the treatment fluid into a subterranean formation; and interacting the alumina nanoparticles with a surface subject to corrosion.
Clause 2. The method of Clause 1, wherein the polyamine dendrimer is bound to a surface of the alumina nanoparticles by a first amine group and a plurality of amine-containing branches extend from a second amine group that is linked to the first amine group.
Clause 3. The method of Clause 2, wherein the amine-containing branches contain a third amine group at a terminus thereof.
Clause 4. The method of Clause 3, wherein the third amine group is a primary amine.
Clause 5. The method of Clause 3 or Clause 4, wherein the amine-containing branches contain an amide linker between the second amine group and the third amine group.
Clause 6. The method of any one of Clauses 1-5, further comprising:
interacting the surface subject to corrosion with a corrosive environment.
Clause 7. The method of Clause 6, wherein the corrosive environment comprises an aqueous acid.
Clause 8. The method of Clause 6 or Clause 7, wherein the treatment fluid provides the corrosive environment.
Clause 9. The method of any one of Clauses 1-6, wherein the treatment fluid comprises an aqueous acid, and the alumina nanoparticles are dispersed in the aqueous acid.
Clause 10. The method of any one of Clauses 1-10, wherein the surface subject to corrosion is located in the subterranean formation.
Clause 11. A composition comprising: a plurality of alumina nanoparticles that are surface modified with a polyamine dendrimer.
Clause 12. The composition of Clause 11, wherein the polyamine dendrimer is bound to a surface of the alumina nanoparticles by a first amine group and a plurality of amine-containing branches extend from a second amine group that is linked to the first amine group.
Clause 13. The composition of Clause 12, wherein the amine-containing branches contain a third amine group at a terminus thereof.
Clause 14. The composition of Clause 13, wherein the third amine group is a primary amine.
Clause 15. The composition of Clause 13 or Clause 14, wherein the amine-containing branches contain an amide linker between the second amine group and the third amine group.
Clause 16. The composition of any one of Clauses 11-15, further comprising: an aqueous acid in which the alumina nanoparticles are dispersed.
Clause 17. A method comprising: providing a plurality of alumina nanoparticles; reacting a diamine with the alumina nanoparticles to bond a first amine group of the diamine to a surface of the alumina nanoparticles; wherein a second amine group of the diamine is linked to the first amine group; and reacting the second amine group of the diamine to form a plurality of amine-containing branches extending from the second amine group.
Clause 18. The method of Clause 17, wherein reacting the second amine group comprises exposing the second amine group to an electrophile under reaction conditions suitable to react the second amine group with the electrophile; wherein the second amine group reacts with two equivalents of the electrophile under the reaction conditions.
Clause 19. The method of Clause 18, wherein the electrophile is a Michael acceptor.
Clause 20. The method of Clause 19, wherein the Michael acceptor is an acrylate ester.
Clause 21. The method of Clause 20, wherein, after reacting the acrylate ester with the second amine group; a second diamine is reacted with the acrylate ester to form the amine-containing branches.
Clause 22. The method of any one of Clauses 17-21, wherein providing the alumina nanoparticles comprises peptizing aluminum hydroxide to form a plurality of colloidal alumina particles and dehydrating.

### EXAMPLES

Synthesis of polyamine dendrimer alumina nanoparticles. Aluminum oxide nanoparticles were synthesized by hydrolysis of aluminum isopropoxide in deionized water at a molar ratio of 1 mole alkoxide to 200 moles water. Hydrolysis was carried out at 90° C. for about 4 hours with stirring. After hydrolysis, hydrochloric acid was added to initiate hydroxide peptization. The hydrochloric acid was added in a ratio of 0.05 moles of acid to 1 mole alkoxide. The acidified mixture was stirred for 2 h until a clear solution was observed. The reaction mixture was then stirred for one day at 90° C. After peptization, sodium bis-2-ethylhexyl sulfosuccinate (C₂₀H₃₇NaO₇) was added in a molar ratio of 0.02 mol to 1 mol alkoxide to conduct a dehydration process to form an alumina network. The dehydration reaction was performed by stirring for 4 hours at 90° C. The resulting alumina nanoparticles were then separated by centrifugation.

About 5 g of the alumina nanoparticles were dispersed in 50 ml of ethylenediamine. The reaction mixture was sonicated for at 70° C. for 4 hours. Thereafter, the reaction mixture was stirred overnight at room temperature. The resulting functionalized nanoparticles were then collected by centrifugation and dried.

The functionalized nanoparticles were suspended in 30 mL methanol and added dropwise with stirring to 30 mL of a solution comprising 50 vol % methyl acrylate and 50 vol % methanol. The reaction mixture was sonicated and refluxed at 70° C. for 4 hours. After the heating period, the reaction mixture was stirred overnight at room temperature, and the resulting electrophile-modified alumina nanoparticles were collected by centrifugation and dried overnight.

Finally, 30 mL of ethylenediamine was added to the electrophile-modified alumina nanoparticles with stirring. The reaction mixture was refluxed at 60° C. for 5 hours, followed by additional stirring at room temperature overnight. The resulting polyamine dendrimer alumina nanoparticles were collected by centrigution and dried.

Corrosion Inhibition Testing. Corrosion inhibition testing was conducted in accordance with ASTM G1-03 (2017). Pre-weighed carbon steel specimens were immersed entirely in 100 mL of a test solution (5% HCl) housed in a 250 mL glass container and held at 90° C. for 4 hours. After 4 hours, each specimen was removed, rinsed with distilled water and acetone, and dried. After drying, the specimens were subsequently weighed. The weight loss of each specimen was determined. Corrosion inhibition testing is summarized in Table 1 against a control sample lacking the polyamine dendrimer alumina nanoparticles.

TABLE 1

| Concentration | | | |
|---|---|---|---|
| Polyamine | | | |
| Dendrimer Alumina | Weight | Weight | Net Weight |
| Nanoparticles | Before (g) | After (g) | Loss (g) |
| None (Control) | 12.0376 | 10.189 | 1.8486 |
| 300 ppm | 12.0161 | 11.744 | 0.2721 |

As shown in Table 1, the polyamine dendrimer alumina nanoparticles afforded significantly increased corrosion inhibition, as evidenced by the lower weight loss as compared to the control lacking the polyamine dendrimer alumina nanoparticles.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What claimed is:

1. A method comprising:
providing a treatment fluid comprising a plurality of alumina nanoparticles that are surface modified with a polyamine dendrimer;
introducing the treatment fluid into a subterranean formation; and
interacting the alumina nanoparticles with a surface subject to corrosion.

2. The method of claim 1, wherein the polyamine dendrimer is bound to a surface of the alumina nanoparticles by a first amine group and a plurality of amine-containing branches extend from a second amine group that is linked to the first amine group.

3. The method of claim 2, wherein the amine-containing branches contain a third amine group at a terminus thereof.

4. The method of claim 3, wherein the amine-containing branches contain an amide linker between the second amine group and the third amine group.

5. The method of claim 1, further comprising:
interacting the surface subject to corrosion with a corrosive environment.

6. The method of claim 5, wherein the corrosive environment comprises an aqueous acid.

7. The method of claim 5, wherein the treatment fluid provides the corrosive environment.

8. The method of claim 1, wherein the treatment fluid comprises an aqueous acid, and the alumina nanoparticles are dispersed in the aqueous acid.

9. The method of claim 1, wherein the surface subject to corrosion is located in the subterranean formation.

10. A composition comprising:
a plurality of alumina nanoparticles that are surface modified with a polyamine dendrimer.

11. The composition of claim 10, wherein the polyamine dendrimer is bound to a surface of the alumina nanoparticles by a first amine group and a plurality of amine-containing branches extend from a second amine group that is linked to the first amine group.

12. The composition of claim 11, wherein the amine-containing branches contain a third amine group at a terminus thereof.

13. The composition of claim 12, wherein the amine-containing branches contain an amide linker between the second amine group and the third amine group.

14. The composition of claim 11, further comprising:
an aqueous acid in which the alumina nanoparticles are dispersed.

15. A method comprising:
providing a plurality of alumina nanoparticles;
reacting a diamine with the alumina nanoparticles to bond a first amine group of the diamine to a surface of the alumina nanoparticles;
wherein a second amine group of the diamine is linked to the first amine group; and
reacting the second amine group of the diamine to form a plurality of amine-containing branches extending from the second amine group.

16. The method of claim 15, wherein reacting the second amine group comprises exposing the second amine group to an electrophile under reaction conditions suitable to react the second amine group with the electrophile;
wherein the second amine group reacts with two equivalents of the electrophile under the reaction conditions.

17. The method of claim 16, wherein the electrophile is a Michael acceptor.

18. The method of claim 17, wherein the Michael acceptor is an acrylate ester.

19. The method of claim 18, wherein, after reacting the acrylate ester with the second amine group; a second diamine is reacted with the acrylate ester to form the amine-containing branches.

20. The method of claim 15, wherein providing the alumina nanoparticles comprises peptizing aluminum hydroxide to form a plurality of colloidal alumina particles and dehydrating.
